(19) United States
(12) Patent Application Publication
(10) Pub. No.: US 2023/0237471 A1
(43) Pub. Date: Jul. 27, 2023

(54) SYSTEM, METHOD, AND NON-TRANSITORY COMPUTER-READABLE STORAGE MEDIA FOR MANAGING NON-FUNGIBLE TOKEN

(71) Applicant: Metaverse Technologies, Inc., Santa Monica, CA (US)

(72) Inventors: Tomas Siedleczka, Santa Monica, CA (US); Noam Man, West Orange, NJ (US)

(21) Appl. No.: 18/099,745

(22) Filed: Jan. 20, 2023

Related U.S. Application Data
(60) Provisional application No. 63/301,632, filed on Jan. 21, 2022.

(51) Int. Cl. G06Q 20/36; G06Q 20/38; G06Q 20/32; G06Q 20/18

(52) U.S. Cl. CPC G06Q 20/3678; G06Q 20/38215; G06Q 20/389; G06Q 20/3274; G06Q 20/18; G06Q 2220/00

(57) ABSTRACT

A networked computer system for storing promotional awards associated with non-fungible tokens (NFTs) is described herein. The networked computer system includes a master engagement record blockchain system including a plurality of master engagement records associated with NFTs, an engagement computer server system, and a plurality of kiosk terminals. A kiosk processor is programmed to capture a dynamic NFT verification (DNV) displayed on a user's mobile device via a kiosk camera and display the plurality of engagement activities via the display touchscreen. The processor of the engagement computer server system performs algorithm steps including determining a promotional award associated with the user selected engagement activity upon receiving the engagement activity completion message from the kiosk processor, and recording a master engagement record to the master engagement record blockchain system associating the determined promotional award with the user owned NFT.

### CROSS-REFERENCE TO RELATED APPLICATION

This application claims benefit of U.S. Provisional Patent Application Ser. No. 63/301,632 filed Jan. 21, 2022, the disclosure of which is hereby incorporated by reference in its entirety.

### FIELD OF THE DISCLOSURE

The present invention relates to networked computer systems for managing non-fungible tokens, and more particularly, to systems, methods, and computer-readable storage media to operate networked computer systems for storing promotional awards associated with non-fungible tokens.

### BACKGROUND

Non-fungible tokens (NFTs) are digital content recorded on blockchain systems such as Ethereum™, Zilliga™, Flow™, Tezos™, etc. NFTs may represent digital artwork such as GIFs, tweets, virtual trading cards, images of physical objects, video game skins, virtual real estate, etc. Each NFT is unique and not mutually interchangeable, which create scarcity among otherwise infinitely available assets. Many consumers desire ownership of NFTs because of their uniqueness. However, as the popularity of NFTs increase, the scarcity among certain types of NFTs, such as digital artwork, becomes less, thus reducing the value of the NFTs.

The present invention is aimed at one or more of the problems identified above.

### SUMMARY OF THE INVENTION

In one aspect of the present invention, a networked computer system for storing promotional awards associated with non-fungible tokens (NFTs) is provided. The networked computer system includes a master engagement record blockchain system including a plurality of master engagement records associated with NFTs, an engagement computer server system including a processor coupled to the master engagement record blockchain system, and a plurality of kiosk terminals coupled to the engagement computer server system. Each kiosk terminal located at a different retail location and including a display touchscreen, a camera, and a kiosk processor. The kiosk processor is programmed to perform an algorithm including the steps of receiving a request from a user to display a plurality of engagement activities via the display touchscreen and displaying a verification prompt image on the display touchscreen requesting the user to display a dynamic NFT verification (DNV) QR code associated with a user owned NFT on a user's mobile device. The kiosk processor is also programmed to perform the algorithm steps including capturing the DNV QR code displayed on the user's mobile device via the kiosk camera, transmitting a verification request including the captured DNV QR code to the engagement computer server system, and displaying the plurality of engagement activities via the display touchscreen upon receiving a DNV QR code verification message from the engagement computer server system. The kiosk processor is also programmed to perform the algorithm steps including receiving a user's selection of a displayed engagement activity via the display touchscreen and transmitting an engagement activity completion message indicating a user selected engagement activity to the engagement computer server system. The processor of the engagement computer server system performs algorithm steps including determining a promotional award associated with the user selected engagement activity upon receiving the engagement activity completion message, and recording a master engagement record to the master engagement record blockchain system associating the determined promotional award with the user owned NFT.

In another aspect of the present invention, a method of operating a networked computer system for storing promotional awards associated with NFTs is provided. The networked computer system includes a master engagement record blockchain system including a plurality of master engagement records associated with NFTs, an engagement computer server system including a processor coupled to the master engagement record blockchain system, and a kiosk terminal including a display touchscreen, a camera, and a kiosk processor. The method includes the kiosk processor performing algorithm steps including receiving a request from a user to display a plurality of engagement activities via the display touchscreen and displaying a verification prompt image on the display touchscreen requesting the user to display a dynamic NFT verification (DNV) QR code associated with a user owned NFT on a user's mobile device. The kiosk processor also performs the algorithm steps including capturing the DNV QR code displayed on the user's mobile device via the kiosk camera, transmitting a verification request including the captured DNV QR code to the engagement computer server system, and displaying the plurality of engagement activities via the display touchscreen upon receiving a DNV QR code verification message from the engagement computer server system. The kiosk processor also performs the algorithm steps including receiving a user's selection of a displayed engagement activity via the display touchscreen and transmitting an engagement activity completion message indicating a user selected engagement activity to the engagement computer server system. The processor of the engagement computer server system performs algorithm steps including determining a promotional award associated with the user selected engagement activity upon receiving the engagement activity completion message, and recording a master engagement record to the master engagement record blockchain system associating the determined promotional award with the user owned NFT.

In yet another aspect of the present invention, one or more non-transitory computer-readable storage media, having computer-executable instructions embodied thereon to operate a networked computer system for storing promotional awards associated with NFTs is provided. The networked computer system including a master engagement record blockchain system including a plurality of master engagement records associated with NFTs, an engagement computer server system including a processor coupled to the master engagement record blockchain system, and a kiosk terminal including a display touchscreen, a camera, and a kiosk processor. When executed by the kiosk processor and the processor of the engagement computer server system, the computer-executable instructions cause the kiosk processor to perform an algorithm including the steps of receiving a request from a user to display a plurality of engagement activities via the display touchscreen and displaying a verification prompt image on the display touchscreen requesting the user to display a dynamic NFT verification (DNV) QR code associated with a user owned NFT on a user's mobile device. The computer-executable instructions also cause the kiosk processor to perform algorithm steps including capturing the DNV QR code displayed on the user's mobile device via the kiosk camera, transmitting a verification request including the captured DNV QR code to the engagement computer server system, and displaying the plurality of engagement activities via the display touchscreen upon receiving a DNV QR code verification message from the engagement computer server system. The computer-executable instructions also cause the kiosk processor to perform algorithm steps including receiving a user's selection of a displayed engagement activity via the display touchscreen and transmitting an engagement activity completion message indicating a user selected engagement activity to the engagement computer server system. The computer-executable instructions also cause the processor of the engagement computer server system to perform algorithm steps including determining a promotional award associated with the user selected engagement activity upon receiving the engagement activity completion message, and recording a master engagement record to the master engagement record blockchain system associating the determined promotional award with the user owned NFT.

### BRIEF DESCRIPTION OF THE FIGURES

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a schematic illustrating various aspects of a system for use in associating real-life experiences and promotional awards to non-fungible tokens (NFT) recorded in a blockchain system, according to the present disclosure;

FIG. 2 is a flow chart illustrating an algorithm used during operation of the system to verify ownership of the NFTs and associating real-life experiences and promotional awards to the NFTs, according to the present disclosure;

FIGS. 3 and 4 are schematic illustrating various aspects of the system;

FIGS. 5-7 are flowcharts illustrating algorithms used during operation of the system to verify ownership of the NFTs and associating real-life experiences and promotional awards to the NFTs, according to the present disclosure;

FIG. 8 is another schematic illustrating various aspects of the system;

FIGS. 9-10 are flowcharts illustrating algorithms used during operation of the system to generate and display touchless applications for use in verify ownership of the NFTs and associating promotional awards to the NFTs, according to the present disclosure;

FIG. 11 is an illustration of a touchless application for use in verify ownership of the NFTs and associating real-life experiences and promotional awards to the NFTs, according to the present disclosure;

FIG. 12 is a flowchart illustrating algorithms used during operation of the system; and

FIGS. 13-15 are illustrations of data files generated and used by the system when implementing the algorithms used during operation of the system.

Corresponding reference characters indicate corresponding parts throughout the drawings.

### DETAILED DESCRIPTION

With reference to the drawings and in operation, the present invention is directed towards a networked computer system for use in associating real-life experiences and promotional awards to non-fungible tokens (NFTs) recorded in a blockchain system.

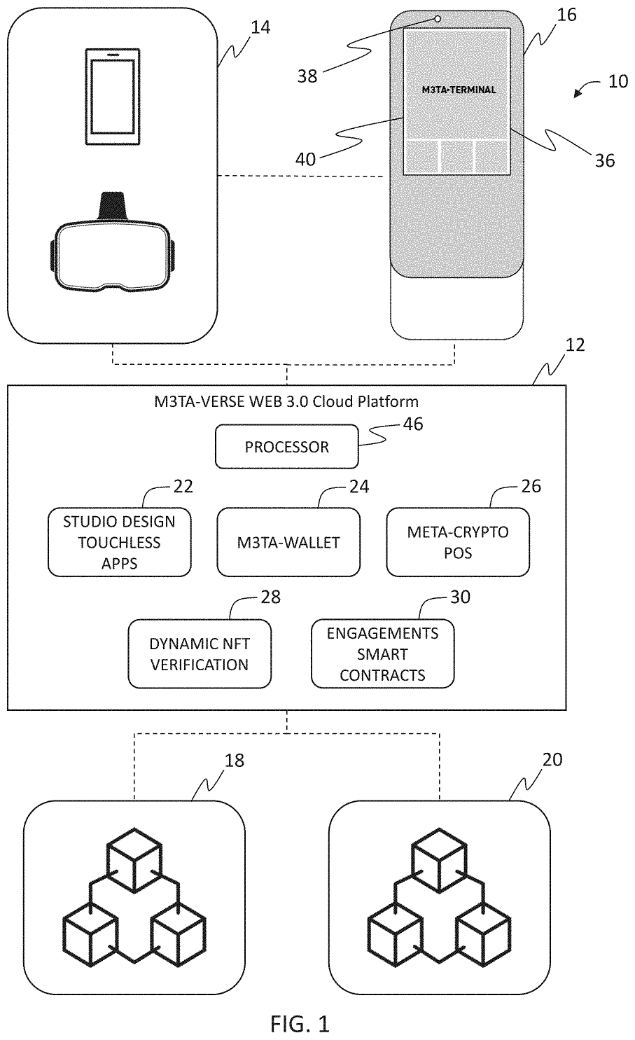

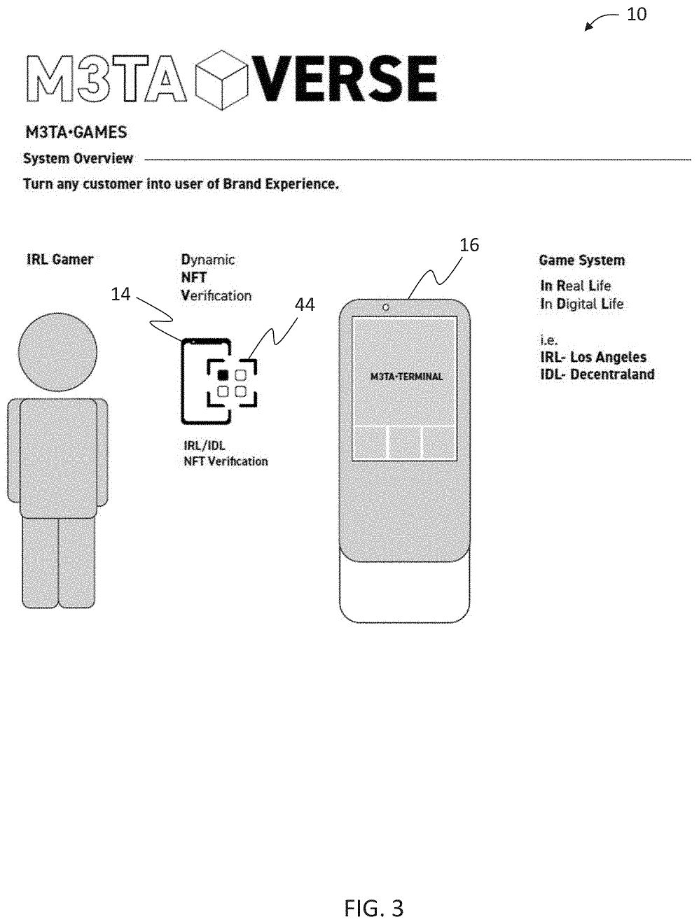

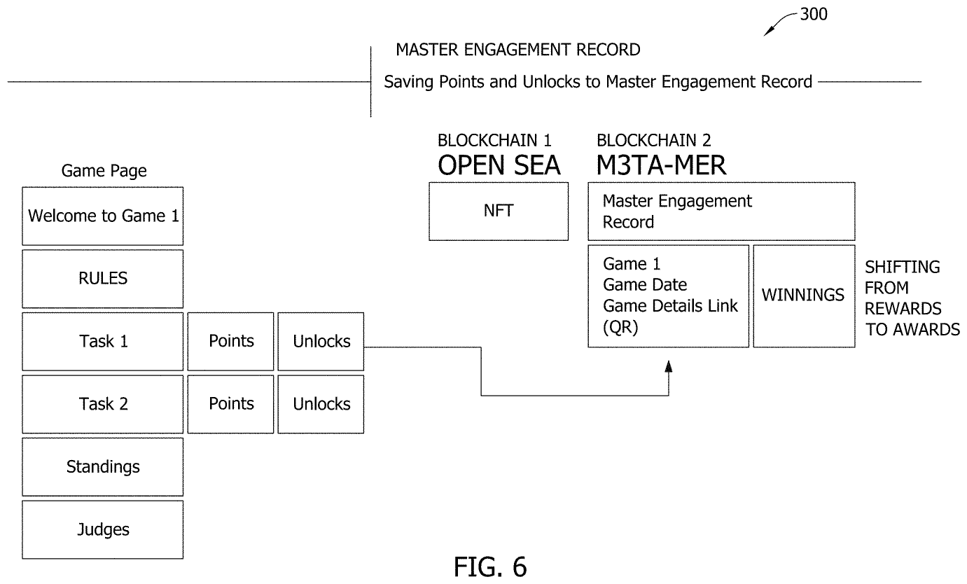

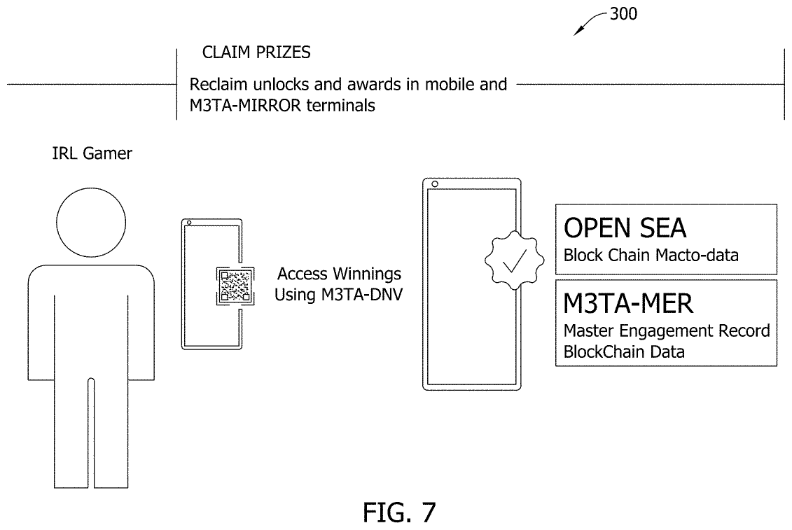

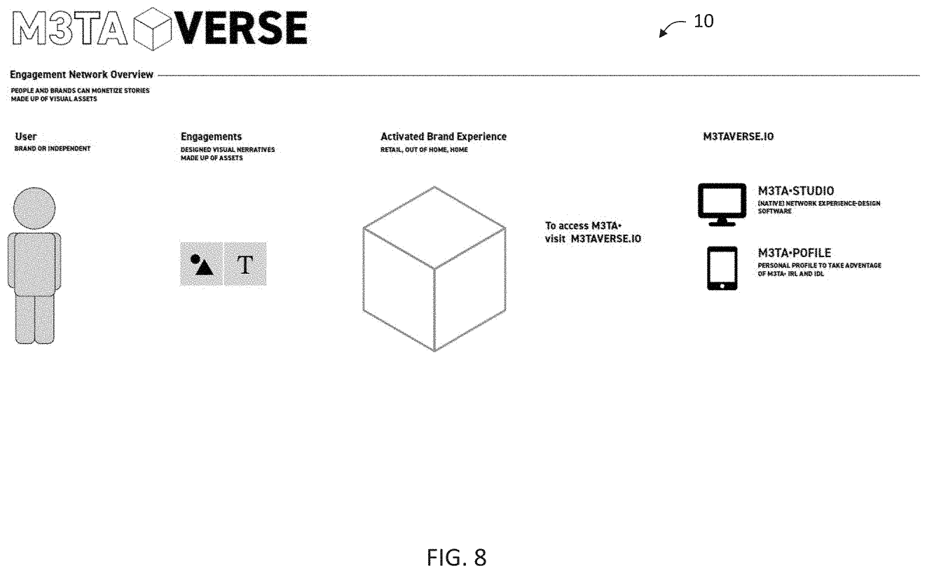

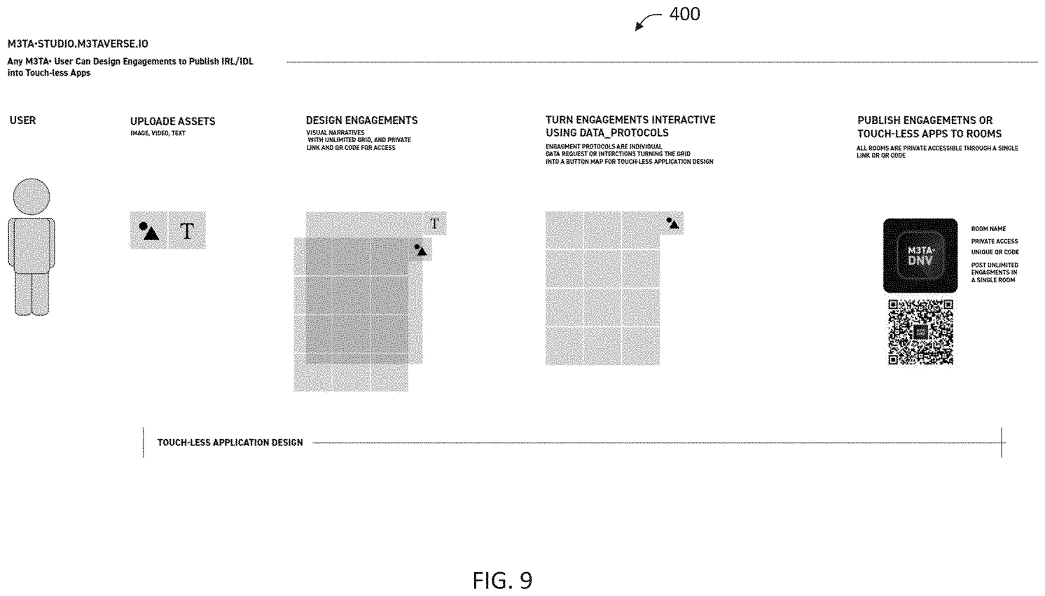

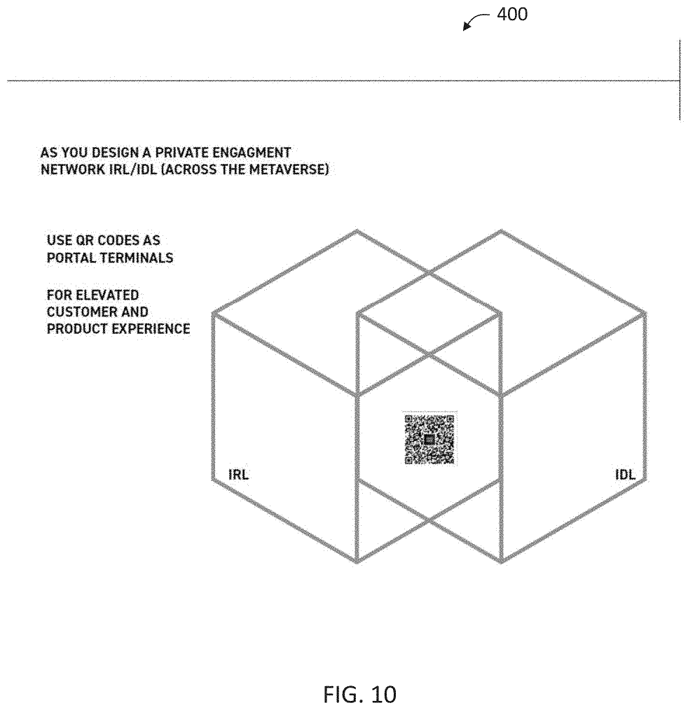

Referring to FIGS. 1-11, the present invention is directed to a networked computer system that includes a M3TA•VERSE™ engagement network 10 for enhanced life. The M3TA•VERSE™ engagement network 10 is a web3.0 environment co-created by people and brands. The basic unit of value is digitized-effort derived from direct-engagements written to smart contracts. People can follow brand experiences to earn crypto, when encountered in the real world. Brands can design touch-less apps using M3TA•Studio™ to incentivize Direct-to-Customer Experiences. The M3TA•VERSE™ engagement network 10 includes touch-less engagements that may be designed and published in real life (IRL) using the M3TA•Studio™

Using the METAVERSE IRL will redefine the people/brand engagement experience. The M3TA•VERSE™ engagement network 10 is powered by an enhanced-experience (EX) engine™ designed to digitize effort using M3TA•GAMES™, starting with user-generated content (UGC) games, moving to scavenger hunts, and multiplayer tournaments, all in real life.

Using the M3TA•VERSE™ engagement network 10 IRL will also redefining how crypto-currencies will be used. Every game begins with an NFT, the only way to Join a game (powered by a Dynamic NFT Verification system). All points and unlocks associated with designed Brand Experiences are captured and written to a new blockchain we call the master engagement record. NFT owners collect value unlocked in gamified engagements increasing the value of “NFT owner experience”. If an NFT ownership changes all unlocks are passed along to the new owner. The M3TA•VERSE™ engagement network 10 integrates the Blockchain NFT Record with the Blockchain Master Engagement Record to associate the master engagement record with the NFT

The M3TA•VERSE™ engagement network 10 also promotes owning the full crypto-currency ownership lifecycle including 1) Mint New NFTs; 2) Accept/Manage Legacy and Crypto Currency; 3) Publish Touch-Less Apps and Gamify Engagements; 4) Recognize Public NFT Records and Master Engagement Record; and 5) Provide Brands with CRYPTO POS To Accept Payment for Products and Services IRL.

The M3TA•VERSE™ engagement network 10 provides real-life NFT games for a new model for enhancing lifestyles. The M3TA•VERSE™ engagement network 10 is configured to enable the following: 1. NFT Communities are invited to play across social networks and discord™; 2. NFT holders “Follow” an Engagement hosting a game.; 3. The community is informed where M3TA•Mirrors™ can be found across a city; 4. Community visits the terminals to kick off a game, check leaderboards and collect unlocks; and 5. The game can play out anywhere earning and spending crypto IRL.

Referring to FIGS. 1, 3, and 8, in the illustrated embodiment, the M3TA•VERSE™ engagement network system 10 includes an engagement computer server system 12 including a M3TA•VERSE™ web3.0 cloud platform that is coupled in communication with a plurality of user computing devices 14, a plurality of M3TA•Mirror™ terminals 16, one or more NFT blockchain systems 18, and a master engagement record blockchain system 20. The user computing devices 14 may include, for example, smartphones, tablet computers, personal computers, virtual-reality headsets, augmented-reality glasses, and/or any suitable device that may be configured to display user-interface (UI) applications that allow users to interact with the M3TA•VERSE™ engagement network 10. For example, the user computing device 14 may include a mobile computing device such as, for example, a tablet computer, a smartphone/tablet computer hybrid, a smartphone such as an iPhone™, Samsung Galaxy™, Google Pixel™ and the like. The mobile computing device includes a processor coupled to a memory device for storing various programs and data for use in operating the mobile computing device, and touchscreen display unit, one or more video image cameras, one or more speakers, a microphone, at least one input button, and one or more sensors including, but not limited to, a barometer, a three-axis gyro, an accelerometer, proximity sensor, and an ambient light sensor. In addition, the mobile computing device may also include a Wi-Fi antenna, a cellular network antenna, a Bluetooth™ communications device, assisted GPS and GLONASS, a digital compass, and an iBeacon™ microlocation device. The mobile computing device may be programmed to store and execute mobile computer program applications that display graphical user interfaces on the touchscreen display unit that allows the user to access the system 10 to retrieve and store information within the system 10 as well as interact with and operate the system 10.

The M3TA•Mirror™ terminals 16 may include touch-sensitive display kiosk terminals that may be configured to display UI applications that allow users to interact with the M3TA•VERSE™ engagement network 10.

The NFT blockchain system 18 includes a blockchain network system that supports NFTs such as, for example, Ethereum™, Zilliga™, Flow™, Tezos™, and/or any suitable blockchain network.

The master engagement record blockchain system 20 includes a blockchain system designed to record master engagement records that are used to record experiences and/or promotional awards associated with NFTs.

The M3TA•VERSE™ web3.0 cloud platform 12 includes a plurality of software program modules including computer-executable instructions that may be executed the computer processor to perform the algorithms describe herein to allow the system 10 to access the NFT blockchain system 18 and verify NFT ownership and allow a user to perform experiences to earn promotional awards that may be associated with the NFT and record the experiences in a master engagement record stored in the master engagement record blockchain system 20 to associate the experiences with the verified NFT.

The M3TA•VERSE™ web3.0 cloud platform 12 includes a M3TA•Studio™ design software module 22, a M3TA•Wallet™ software module 24, a M3TA•Crypto™ point-of-sale software module 26, a dynamic NFT verification software module 28, and engagement smart contracts 30.

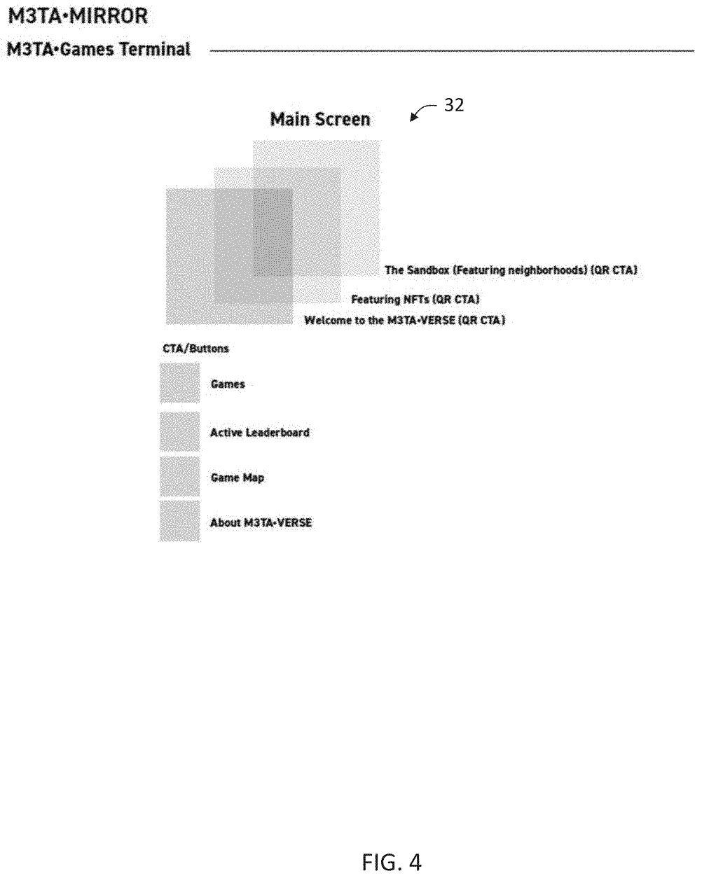

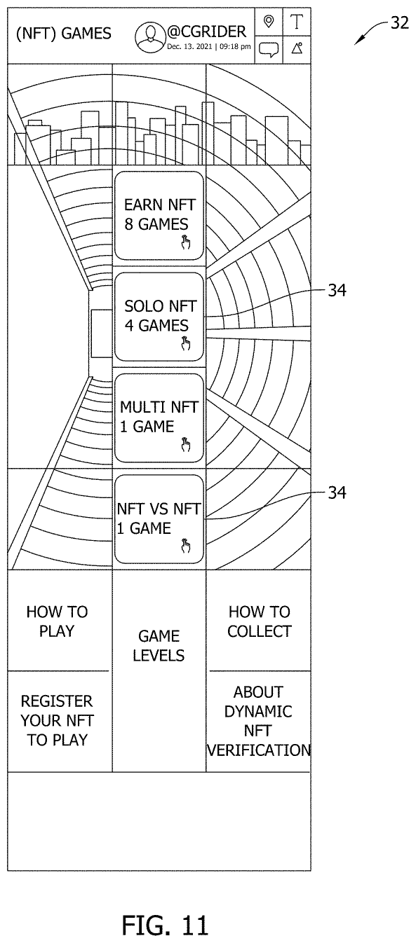

The M3TA•Studio™ design software module 22 includes computer-executable instructions that design and publish touchless applications 32 (shown in FIGS. 4 and 11) that may be displayed on the user computing devices 14, on the M3TA•Mirror™ terminals 16, and within virtual world environments (e.g., Decentraland™), to allow users to interact with the M3TA•VERSE™ engagement network 10 and design and publish touchless applications 32 and gamify engagements. Touchless applications 32 may be published and displayed on the NFT blockchain system 18 and/or the master engagement record blockchain system 20.

The M3TA•Wallet™ software module 24 includes computer-executable instructions for executing an algorithm to enable users to accept/manage legacy and crypto currency.

The M3TA•Crypto™ point-of-sale software module 26 includes computer-executable instructions for executing an algorithm to provide brands with crypto point-of-sale function to accept crypto currency as payment for products and services in real life (IRL).

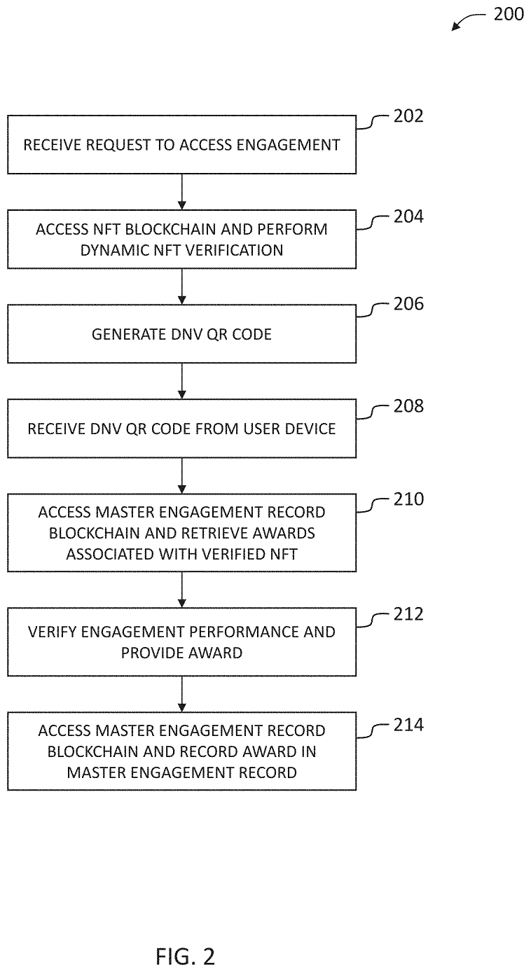

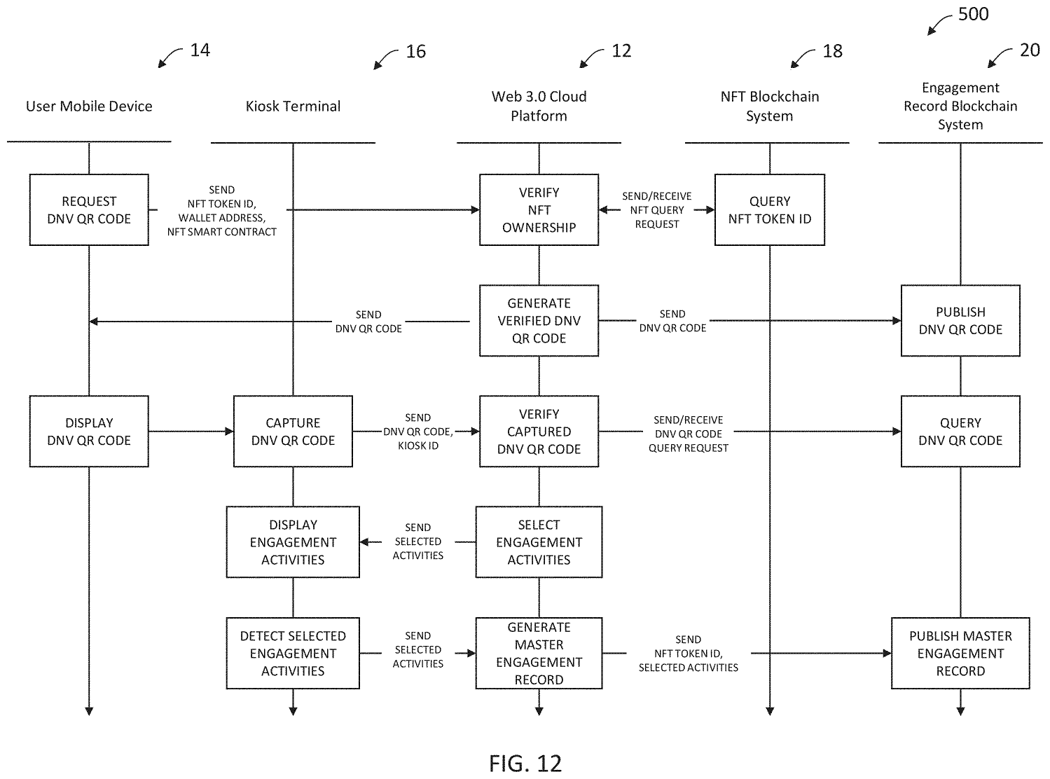

The dynamic NFT verification software module 28 includes computer-executable instructions for executing the algorithms 200, 300, 400, and 500 shown in FIGS. 2, 5-7, 8-10, and 12 to verify ownership of NFTs used to associated completed experiences and received promotional awards.

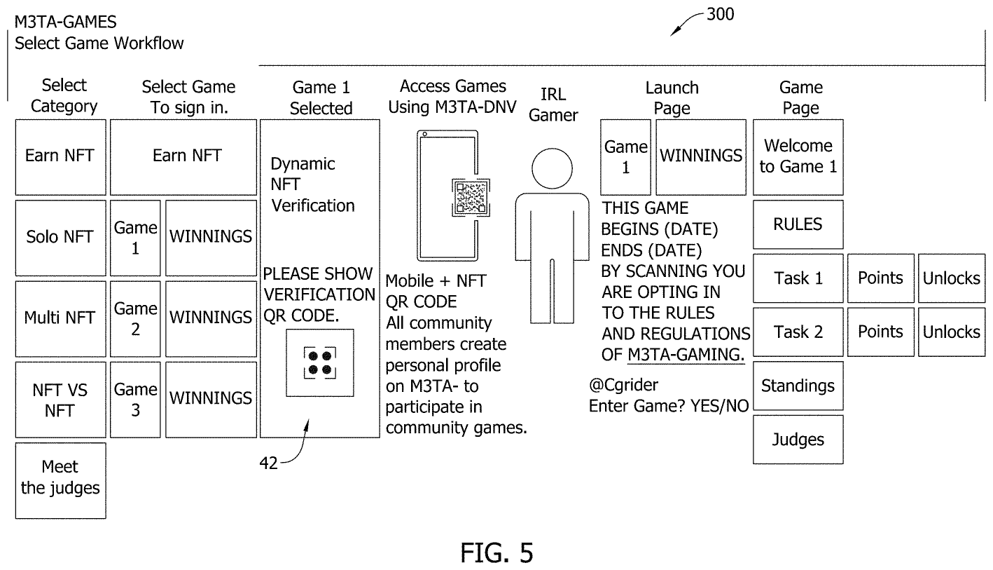

The engagement smart contracts 30 includes computer-executable instructions published to the blockchains systems 18, 20 for executing the algorithm 200, 300, 400 and 500 shown in FIGS. 5-7, 8-10, and 12.

FIGS. 5-7, 8-10, and 12 are flowcharts of methods 200, 300, 400, and 500 illustrating the algorithms executed by the M3TA•VERSE™ engagement network 10 for associated experiences completed by users in real life with NFTs and to design and publish touchless applications 32 that facilitate user interaction with the M3TA•VERSE™ engagement network 10 to complete the experiences and receive promotional awards. The methods include a plurality of steps. Each method step may be performed independently of, or in combination with, other method steps. Portions of the methods may be performed by any one of, or any combination of, the components of the M3TA•VERSE™ engagement network 10.

For example, in some embodiments, in method step 202, a processor of the M3TA•VERSE™ web3.0 cloud platform 12 may receive a request by a user to access an engagement via a touchless application 32 being displayed on a M3TA•Mirror™ terminal 16. For example, the M3TA•Studio™ design software module 22 to display the touchless application 32 on M3TA•Mirror™ terminal 16 to allow the user to interact with the M3TA•VERSE™ web3.0 cloud platform 12 to record completed engagements to an NFT.

Upon receiving the user request, the dynamic NFT verification software module 28 may execute method step 204 and send a request to a user computing device 14 prompting the user to verify ownership of an NFT. The dynamic NFT verification software module 28 then receives data associated with the NFT from the user computing device 14 and executes an engagement smart contract 30 published to the NFT blockchain system 18 to identify records associated with the NFT and verify the user's ownership of the NFT. Upon dynamically verifying ownership of the NFT, the dynamic NFT verification software module 28 executes method step 206 to generate a dynamic NFT Verification (DNV) QR code associated with the verified NFT which is displayed on the user computing device 14 of the user.

In method step 208, the M3TA•Mirror™ terminal 16 is operated to detect the DNV QR code displayed on the user's device 14 and transmits the DNV QR code to the M3TA•VERSE™ web3.0 cloud platform 12.

In method step 210, upon receiving the DNV QR code from the M3TA•Mirror™ terminal 16, the M3TA•VERSE™ web3.0 cloud platform 12 executes an engagement smart contract 30 published to the master engagement record blockchain system 20 to identify master engagement record associated with the verified NFT that includes data associated with completed engagements, promotional awards, eligible gamified experiences, etc. The M3TA•Studio™ design software module 22 may then display the data from the identify master engagement record on the touchless application 32. The M3TA•Studio™ design software module 22 may also display a plurality of gamified engagements 34 on the touchless application 32 to allow the user to select one or more of the gamified engagements 34 to be completed to earn promotional awards.

In method step 212, a processor of the M3TA•VERSE™ web3.0 cloud platform 12 receives an indication that one or more user selected gamified engagements 34 has been completed, verifies the performance of the user selected gamified engagement 34, and identifies a promotional award associated with the completed engagement.

In method step 214, the processor of the M3TA•VERSE™ web3.0 cloud platform 12 executes the engagement smart contract 30 published to the master engagement record blockchain system 20 to identify the master engagement record associated with the verified NFT and record the completed engagement and any associated promotional awards to the master engagement record blockchain system 20. The master engagement record associated with the verified NFT may also be accessible in an NFT marketplace such as, for example, OpenSea™.

In some embodiments, the networked computer system 10 includes the master engagement record blockchain system 20 including a plurality of master engagement records associated with NFTs, the engagement computer server system 12 including a processor coupled to the master engagement record blockchain system, and a plurality of kiosk terminals 16 coupled to the engagement computer server system. Each kiosk terminal 16 is located at a different retail location and includes a display touchscreen 36, a camera 38, and a kiosk processor 40 in communication with processor 46 of the engagement computer server system 12 via a communications network. The communications network may be any suitable connection, including the Internet, file transfer protocol (FTP), an Intranet, LAN, a virtual private network (VPN), cellular networks, etc. . . . , and may utilize any suitable or combination of technologies including, but not limited to, wired and wireless connections, always on connections, connections made periodically, and connections made as needed.

When executing the algorithms 200, 300, 400, and 500, the kiosk processor 40 performs the algorithm steps including receiving a request from a user to display a plurality of engagement activities via the display touchscreen 36 and displaying a verification prompt image 42 on the display touchscreen 36 requesting the user to display a dynamic NFT verification (DNV) QR code 44 associated with a user owned NFT on a user's mobile device 14. The kiosk processor captures the DNV QR code 44 displayed on the user's mobile device 14 via the kiosk camera 38 and transmits a verification request including the captured DNV QR code 44 to the engagement computer server system 12.

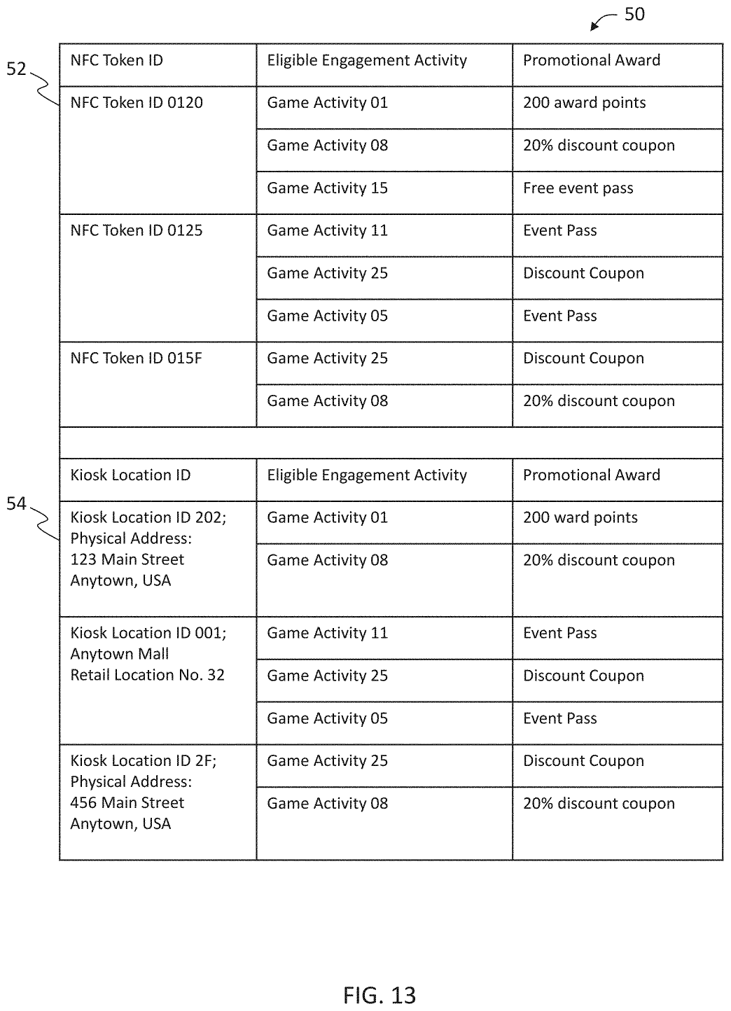

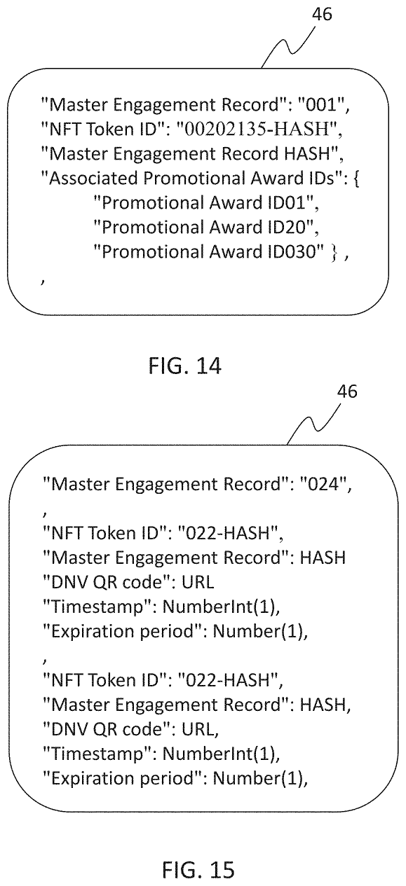

The kiosk processor then displays the plurality of engagement activities 34 via the display touchscreen 36 upon receiving a DNV QR code verification message from the engagement computer server system 12. The kiosk processor then receives a user's selection of a displayed engagement activity 34 via the display touchscreen 36 and transmit an engagement activity completion message indicating a user selected engagement activity to the engagement computer server system 12. The processor 46 of the engagement computer server system 12 then performs algorithm steps including determining a promotional award associated with the user selected engagement activity upon receiving the engagement activity completion message, and recording a master engagement record 48 (shown in FIG. 13) to the master engagement record blockchain system 20 associating the determined promotional award with the user owned NFT.

The kiosk terminal 16 may also display an account image icon that allows the user to view current promotional awards associated with the user owned NFT. For example, upon receiving a user's selection of the account image icon, the kiosk processor 40 send an account request and the captured DNV QR code to the engagement computer server system 12. Upon receiving the account request and the captured DNV QR code from the kiosk processor 40, the processor 46 of the engagement computer server system 12 implements the steps of querying the master engagement record blockchain system 20 to identify the master engagement record 48 associated with the identified NFT token ID, identifying current promotional awards included in the identified master engagement record 48 associated with the identified NFT token ID; and sending the current promotional awards included in the identified master engagement record to the kiosk processor to display via the display touchscreen 36.

In some embodiments, the processor 46 of the engagement computer server system 12 performs algorithm steps including identifying an NFT token ID associated with the captured DNV QR code, determining eligible engagement activities associated with the identified NFT token ID; and transmitting the DNV QR code verification message including the eligible engagement activities to display via the display touchscreen 36. For example, the processor 46 of the engagement computer server system 12 may access an eligible engagement activity file 50 (shown in FIG. 13) stored on the web3.0 platform 12 which includes eligible engagement activities 34 associated with a plurality of NFT Token IDs 52. The processor then identifies the eligible engagement activities 34 associated with the NFT Token ID 52 included in the captured DNV QR code 44 and sends information associated with the identified the eligible engagement activities 34 to the kiosk processor 40 for use in displaying the eligible engagement activities on the display touchscreen 36 to allow the user to select one or more of the displayed engagement activities to associate with the NFT Token ID 52.

The kiosk processor may also be programmed to transmit the verification request to the engagement computer server system including the captured DNV QR code and a kiosk location ID 54 identifying a physical location of the corresponding kiosk terminal 16. The processor 46 of the engagement computer server system 12 is programmed to identify the physical location of the corresponding kiosk terminal 16 based on the kiosk location ID and determine the eligible engagement activities based on the identified physical location of the corresponding kiosk terminal 16. For example, the eligible engagement activity file 50 stored on the web3.0 platform 12 may also include eligible engagement activities 34 associated with a plurality of physical kiosk terminal locations identified by kiosk location IDs 54. The processor then queries the eligible engagement activity file 50 to identify the physical location of the corresponding kiosk terminal 16 based on the kiosk location ID 54, determines the eligible engagement activities based on the identified physical location of the corresponding kiosk terminal 16, and sends information associated with the identified the eligible engagement activities 34 to the kiosk processor 40 for use in displaying the eligible engagement activities on the display touchscreen 36.

In the illustrated embodiment, the processor 46 of the engagement computer server system 12 is programmed to performs algorithm steps including receiving a request for generating the DNV QR code associated with the user owned NFT from the user's mobile device 14. For example, the user's mobile device 14 may include smartphone, such as an iPhone™, Samsung Galaxy™, Google Pixel™ and the like, that includes a mobile software application stored in the memory device of the user's smartphone which enables the user to request and display QR codes on the touchscreen display of the smartphone. Upon receiving the request for generating the DNV QR code from the user's smartphone, the processor 46 of the engagement computer server system 12 transmits the DNV QR code to the user's mobile device 14 to display the DNV QR code on the user's mobile device 14.

In some embodiments, the processor 46 of the engagement computer server system 12 receives the request for generating the DNV QR code 44 from the user's mobile device 14 including a user's wallet address associated with the user, an NFT smart contract address, and a NFT token ID associated with the user owned NFT. The engagement computer server system 12 then verifies ownership of the user owned NFT by querying the NFT blockchain system 18 identified by the NFT smart contract address and NFT token ID to identify a current wallet address associated with the NFT token ID. The engagement computer server system 12 then generates the DNV QR code 44 upon determining the current wallet address matches the user's wallet address and transmits the generated DNV QR code 44 to the user's mobile device 14.

The processor 46 of the engagement computer server system 12 may also transmit the generated DNV QR code including an expiration time period and/or timestamp. When the kiosk processor captures the DNV QR code 44 displayed on the user's mobile device 14 and transmits the verification request including the captured DNV QR code 44 to the engagement computer server system 12, the processor 46 of the engagement computer server system 12 then transmits the DNV QR code verification message to the kiosk processor upon determining the verification request received from the kiosk processor is received within the expiration time period.

In some embodiments, the processor 46 of the engagement computer server system 12 may record a master engagement record 48 to the master engagement record blockchain system 20 associating the generated DNV QR code 44 with the verified NFT Token ID 52. When the kiosk processor captures a DNV QR code displayed on the user's mobile device 14 and transmits the verification request including the captured DNV QR code 44 to the engagement computer server system 12, the processor 46 of the engagement computer server system 12 may query the master engagement record blockchain system 20 to identify the master engagement record 48 to verify the captured DNV QR code.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. In addition, a central processing unit (CPU) may include one or more processors as described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention.

What is claimed is:

1. A networked computer system for storing promotional awards associated with non-fungible tokens (NFTs), comprising:
a master engagement record blockchain system including a plurality of master engagement records associated with NFTs;
an engagement computer server system including a processor coupled to the master engagement record blockchain system; and
a plurality of kiosk terminals coupled to the engagement computer server system, each kiosk terminal located at a different retail location and including a display touchscreen, a camera, and a kiosk processor programmed to perform an algorithm including the steps of:
receiving a request from a user to display a plurality of engagement activities via the display touchscreen and displaying a verification prompt image on the display touchscreen requesting the user to display a dynamic NFT verification (DNV) QR code associated with a user owned NFT on a user's mobile device;
capturing the DNV QR code displayed on the user's mobile device via the kiosk camera and transmitting a verification request including the captured DNV QR code to the engagement computer server system;
displaying the plurality of engagement activities via the display touchscreen upon receiving a DNV QR code verification message from the engagement computer server system;
receiving a user's selection of a displayed engagement activity via the display touchscreen and transmitting an engagement activity completion message indicating a user selected engagement activity to the engagement computer server system;
wherein the processor of the engagement computer server system performs algorithm steps including:
determining a promotional award associated with the user selected engagement activity upon receiving the engagement activity completion message; and
recording a master engagement record to the master engagement record blockchain system associating the determined promotional award with the user owned NFT.

2. The networked computer system of claim 1, wherein the processor of the engagement computer server system performs algorithm steps including:
identifying an NFT token ID associated with the captured DNV QR code;
determining eligible engagement activities associated with the identified NFT token ID; and
transmitting the DNV QR code verification message including the eligible engagement activities to display via the display touchscreen.

3. The networked computer system of claim 2, wherein the kiosk processor performs algorithm steps including:
transmitting the verification request to the engagement computer server system including the captured DNV QR code and a kiosk location ID identifying a corresponding kiosk terminal;
the processor of the engagement computer server system performs algorithm steps including:
identifying a physical location of the corresponding kiosk terminal based on the kiosk location ID; and
determining the eligible engagement activities based on the identified physical location of the corresponding kiosk terminal.

4. The networked computer system of claim 2, wherein the processor of the engagement computer server system performs algorithm steps including:
receiving an account request to display promotional awards from the kiosk processor;
querying the master engagement record blockchain system to identify the master engagement record associated with the identified NFT token ID;
identifying current promotional awards included in the identified master engagement record associated with the identified NFT token ID; and
sending the current promotional awards included in the identified master engagement record to the kiosk processor to display via the touchscreen display.

5. The networked computer system of claim 1, wherein the processor of the engagement computer server system performs algorithm steps including:
receiving a request for generating the DNV QR code associated with the user owned NFT from the user's mobile device; and
transmitting the DNV QR code to the user's mobile device to display the DNV QR code on the user's mobile device.

6. The networked computer system of claim 5, wherein the processor of the engagement computer server system performs algorithm steps including:
receiving the request for generating the DNV QR code from the user's mobile device including a user's wallet address associated with the user, an NFT smart contract address, and a NFT token ID associated with the user owned NFT.

7. The networked computer system of claim 6, wherein the processor of the engagement computer server system performs algorithm steps including:
verifying ownership of the user owned NFT by:
querying an NFT blockchain system identified by the NFT smart contract address and NFT token ID to identify a current wallet address associated with the NFT token ID; and
generating the DNV QR code upon determining the current wallet address matches the user's wallet address; and
transmitting the generated DNV QR code to the user's mobile device.

8. The networked computer system of claim 7, wherein the processor of the engagement computer server system performs algorithm steps including:
transmitting the generated DNV QR code including an expiration time period; and
transmitting the DNV QR code verification message to the kiosk processor upon determining the verification request received from the kiosk processor is received within the expiration time period.

9. A method of operating a networked computer system for storing promotional awards associated with NFTs, the networked computer system including a master engagement record blockchain system including a plurality of master engagement records associated with NFTs, an engagement computer server system including a processor coupled to the master engagement record blockchain system, and a kiosk terminal including a display touchscreen, a camera, and a kiosk processor, the method comprising:
the kiosk processor performing algorithm steps including:
receiving a request from a user to display a plurality of engagement activities via the display touchscreen and displaying a verification prompt image on the display touchscreen requesting the user to display a dynamic NFT verification (DNV) QR code associated with a user owned NFT on a user's mobile device;
capturing the DNV QR code displayed on the user's mobile device via the kiosk camera and transmitting a verification request including the captured DNV QR code to the engagement computer server system;
displaying the plurality of engagement activities via the display touchscreen upon receiving a DNV QR code verification message from the engagement computer server system; and
receiving a user's selection of a displayed engagement activity via the display touchscreen and transmitting an engagement activity completion message indicating a user selected engagement activity to the engagement computer server system; and
the processor of the engagement computer server system performing algorithm steps including:
determining a promotional award associated with the user selected engagement activity upon receiving the engagement activity completion message; and
recording a master engagement record to the master engagement record blockchain system associating the determined promotional award with the user owned NFT.

10. The method of claim 9, comprising the processor of the engagement computer server system performing algorithm steps including:
identifying an NFT token ID associated with the captured DNV QR code;
determining eligible engagement activities associated with the identified NFT token ID; and
transmitting the DNV QR code verification message including the eligible engagement activities to display via the display touchscreen.

11. The method of claim 10, comprising:
the kiosk processor performing algorithm steps including:
transmitting the verification request to the engagement computer server system including the captured DNV QR code and a kiosk location ID identifying a corresponding kiosk terminal; and
the processor of the engagement computer server system performing algorithm steps including:
identifying a physical location of the corresponding kiosk terminal based on the kiosk location ID; and
determining the eligible engagement activities based on the identified physical location of the corresponding kiosk terminal.

12. The method of claim 10, comprising the processor of the engagement computer server system performing algorithm steps including:
receiving an account request to display promotional awards from the kiosk processor;
querying the master engagement record blockchain system to identify the master engagement record associated with the identified NFT token ID;
identifying current promotional awards included in the identified master engagement record associated with the identified NFT token ID; and
sending the current promotional awards included in the identified master engagement record to the kiosk processor to display via the touchscreen display.

13. The method of claim 9, comprising the processor of the engagement computer server system performing algorithm steps including:
receiving a request for generating the DNV QR code associated with the user owned NFT from the user's mobile device; and
transmitting the DNV QR code to the user's mobile device to display the DNV QR code on the user's mobile device.

14. The method of claim 13, comprising the processor of the engagement computer server system performing algorithm steps including:
receiving the request for generating the DNV QR code from the user's mobile device including a user's wallet address associated with the user, an NFT smart contract address, and a NFT token ID associated with the user owned NFT.

15. The method of claim 14, comprising the processor of the engagement computer server system performing algorithm steps including:
verifying ownership of the user owned NFT by:
querying an NFT blockchain system identified by the NFT smart contract address and NFT token ID to identify a current wallet address associated with the NFT token ID; and
generating the DNV QR code upon determining the current wallet address matches the user's wallet address; and
transmitting the generated DNV QR code to the user's mobile device.

16. The method of claim 15, comprising the processor of the engagement computer server system performing algorithm steps including:
transmitting the generated DNV QR code including an expiration time period; and
transmitting the DNV QR code verification message to the kiosk processor upon determining the verification request received from the kiosk processor is received within the expiration time period.

17. A non-transitory computer-readable storage media having computer-executable instructions embodied thereon to operate a networked computer system for storing promotional awards associated with NFTs, the networked computer system including a master engagement record blockchain system including a plurality of master engagement records associated with NFTs, an engagement computer server system including a processor coupled to the master engagement record blockchain system, and a kiosk terminal including a display touchscreen, a camera, and a kiosk processor, when executed by the kiosk processor and the processor of the engagement computer server system, the computer-executable instructions cause:
the kiosk processor to perform an algorithm including the steps of:
receiving a request from a user to display a plurality of engagement activities via the display touchscreen and displaying a verification prompt image on the display touchscreen requesting the user to display a dynamic NFT verification (DNV) QR code associated with a user owned NFT on a user's mobile device;
capturing the DNV QR code displayed on the user's mobile device via the kiosk camera and transmitting a verification request including the captured DNV QR code to the engagement computer server system;
displaying the plurality of engagement activities via the display touchscreen upon receiving a DNV QR code verification message from the engagement computer server system; and
receiving a user's selection of a displayed engagement activity via the display touchscreen and transmitting an engagement activity completion message indicating a user selected engagement activity to the engagement computer server system; and
cause the processor of the engagement computer server system to perform algorithm steps including:
determining a promotional award associated with the user selected engagement activity upon receiving the engagement activity completion message; and
recording a master engagement record to the master engagement record blockchain system associating the determined promotional award with the user owned NFT.

18. The non-transitory computer-readable storage media of claim 17, wherein the computer-executable instructions cause the processor of the engagement computer server system performs algorithm steps including:
identifying an NFT token ID associated with the captured DNV QR code;
determining eligible engagement activities associated with the identified NFT token ID; and
transmitting the DNV QR code verification message including the eligible engagement activities to display via the display touchscreen.

19. The non-transitory computer-readable storage media of claim 17, wherein the computer-executable instructions cause:
the kiosk processor to perform algorithm steps including:
transmitting the verification request to the engagement computer server system including the captured DNV QR code and a kiosk location ID identifying a corresponding kiosk terminal; and
cause the processor of the engagement computer server system to perform algorithm steps including:
identifying a physical location of the corresponding kiosk terminal based on the kiosk location ID; and
determining the eligible engagement activities based on the identified physical location of the corresponding kiosk terminal.

20. The non-transitory computer-readable storage media of claim 17, wherein the computer-executable instructions cause the processor of the engagement computer server system to perform algorithm steps including:
receiving a request for generating the DNV QR code associated with the user owned NFT from the user's mobile device including a user's wallet address associated with the user, an NFT smart contract address, and a NFT token ID associated with the user owned NFT;
verifying ownership of the user owned NFT by:
querying an NFT blockchain system identified by the NFT smart contract address and NFT token ID to identify a current wallet address associated with the NFT token ID; and
generating the DNV QR code upon determining the current wallet address matches the user's wallet address; and
transmitting the generated DNV QR code to the user's mobile device to the user's mobile device to display the generated DNV QR code on the user's mobile device.
